(19) United States
(12) Patent Application Publication
(10) Pub. No.: US 2006/0090126 A1
(43) Pub. Date: Apr. 27, 2006

(54) Method, system, and storage medium for providing instant text character identification

(75) Inventor: Christopher T. Cring, Poughkeepsie, NY (US)

Correspondence Address: CANTOR COLBURN LLP, 55 GRIFFIN ROAD SOUTH, BLOOMFIELD, CT, 06002, US

(73) Assignee: International Business Machines Corporation, Armonk, NY (US)

(21) Appl. No.: 10/973,904

(22) Filed: Oct. 26, 2004

(51) Int. Cl. G06F 17/00

(52) U.S. Cl. 715/509; 715/542

(57) ABSTRACT

Embodiments include a method, system, and storage medium for providing instant text character identification. The method includes querying a code page for a character selected for identification, the querying implemented in response to a request for the identification by a user at a computer device. The request for identification includes an input string of characters to be identified. The method also includes creating a table and entering the character selected for identification and an identification resulting from the querying. The method further includes displaying the table to a user via the computer device. The identification includes corresponding alpha properties or numeric properties of the character selected for identification.

### BACKGROUND OF THE INVENTION

The invention relates generally to data processing and, in particular, to a method, system, and storage medium for providing instant text character identification.

In today's computer-driven society, individuals and businesses rely on computer- or machine-generated information. The traditional manual methods of creating documents such as invoices, contracts, receipts, etc., are increasingly being replaced by computers or other automated devices. Many of these documents generally contain information that is important to individuals and businesses (e.g., pricing data, serial numbers, addresses, warranty information, etc.). When these documents are displayed on a computer device, the important information contained therein is oftentimes difficult to interpret due to, e.g., the font type and/or font size used in creating or displaying the document, similarities between specific characters provided in the documents, disparate software applications used in generating the documents, as well as other factors. In particular, with respect to character similarities, it is often difficult to ascertain or identify alpha or numeric text that share similar characteristics with other alpha or numeric text. For example, the lower case letter ‘l’ and the number ‘1’, and the upper case letter ‘O’ and the number ‘0’ are two examples of alphanumeric characters that are oftentimes confusingly similar in appearance.

What is needed, therefore, is a way to instantly identify one or more alphanumeric characters for a variety of font types and/or applications used in the implementation of the characters.

### BRIEF SUMMARY OF THE INVENTION

Exemplary embodiments include a method, system, and storage medium for providing instant text character identification. The method includes querying a code page for a character selected for identification, the querying implemented in response to a request for the identification by a user at a computer device. The request for identification includes an input string of characters to be identified. The method also includes creating a table and entering the character selected for identification and an identification resulting from the querying. The method further includes displaying the table to a user via the computer device. The identification includes corresponding alpha properties or numeric properties of the character selected for identification.

Additional exemplary embodiments include a system for providing instant text character identification. The system includes a computer device executing an operating system and at least one of a web browser and a word processing application. The system also includes a character identification application executing on the computer device. The character identification application queries a code page for a character selected for identification. The querying is implemented in response to a request for the identification by a user at the computer device. The character identification application also creates a table and enters the character selected for identification and an identification resulting from the query. The character identification application further displays the table to a user via the computer device. The identification includes corresponding alpha properties or numeric properties of the character selected for identification.

Further exemplary embodiments include a storage medium encoded with machine-readable program code for providing instant text character identification. The program code includes instructions for causing a computer device to implement a method. The method includes querying a code page for a character selected for identification, the querying implemented in response to a request for the identification by a user at a computer device. The request for identification includes an input string of characters to be identified. The method also includes creating a table and entering the character selected for identification and an identification resulting from the querying. The method further includes displaying the table to a user via the computer device. The identification includes corresponding alpha properties or numeric properties of the character selected for identification.

### BRIEF DESCRIPTION OF THE DRAWINGS

Referring now to the drawings wherein like elements are numbered alike in the several FIGURES:

FIG. 1 depicts a system upon which the character identification system may be implemented in exemplary embodiments;

FIG. 2 is a flow diagram of a process for implementing the character identification system processes in exemplary embodiments; and

FIG. 3 is a user interface screen illustrating sample data provided by the character identification system in exemplary embodiments.

### DETAILED DESCRIPTION OF THE PREFERRED EMBODIMENTS

Exemplary embodiments of the present invention provide instant recognition of one or more characters displayed on a computer screen. Characters or character strings may be selected in the course of viewing the characters/strings using any viewer (e.g., Internet browser, editor, word processor, etc.) for identification. A character identification application identifies the selected characters/string and displays the identification in a table format or similar convenient display means. The identification includes differentiating between upper and lower case alpha characters and numeric characters. The identification values may be saved, printed, or transferred to written form for later reference.

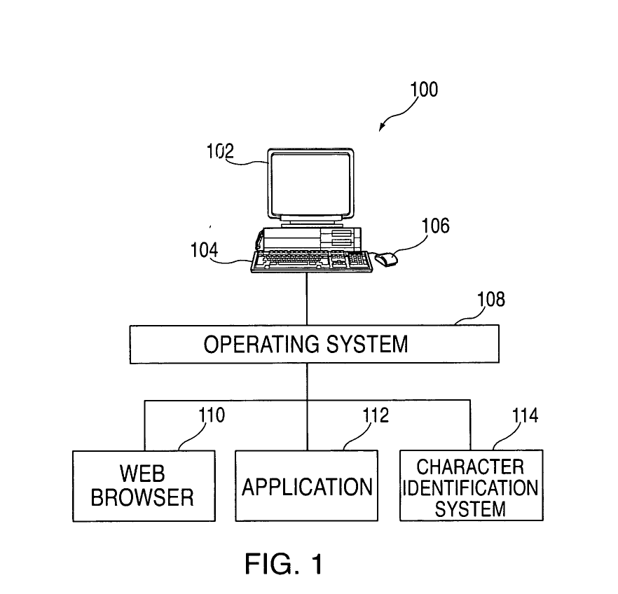

Turning now to FIG. 1, an exemplary system upon which the character identification system may be implemented will now be described. FIG. 1 includes a computer 100 which, in turn, includes various components typically found on a computing device, such as a processor (not shown), one or more input devices 104/106, and an output device 102. Computer 100 may comprise a general-purpose computer, laptop, or wireless device (e.g., mobile handheld device). Further, computer 100 may be a network computer or utilize a network service provider for accessing one or more computer systems coupled to a network.

In accordance with exemplary embodiments, computer 100 executes an operating system 108 for managing the execution of other programs running on computer 100. The operating system 108 may be, for example, DOS, OS/2, Linux, or other suitable operating system. Computer 100 may also execute a web browser 110 and one or more applications 112 (e.g., word processing software, accounting program, legacy application, etc.). Computer 100 further executes the character identification system 114 of the invention. The character identification system 114 includes an application for implementing the processes described herein. The character identification system 114 may include a ‘plug-in’ software application that interfaces with operating system 108 and one or both of web browser 110 and application 112. Alternatively, the character identification system 114 may be built in to one or more applications executing on computer 100.

While not specifically shown in FIG. 1, computer 100 may be coupled to one or more peripheral devices (e.g., printer, facsimile, external disk drive, etc.).

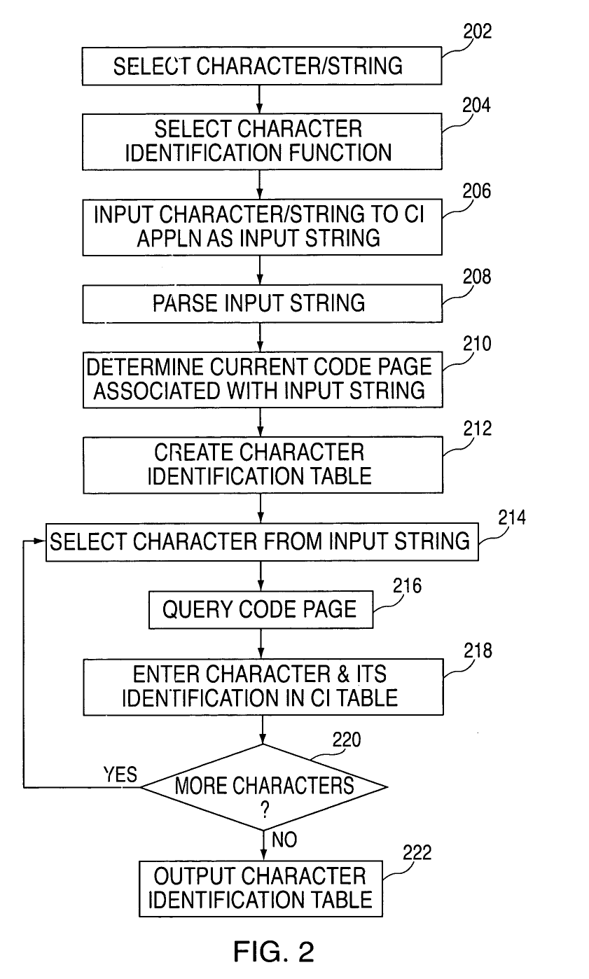

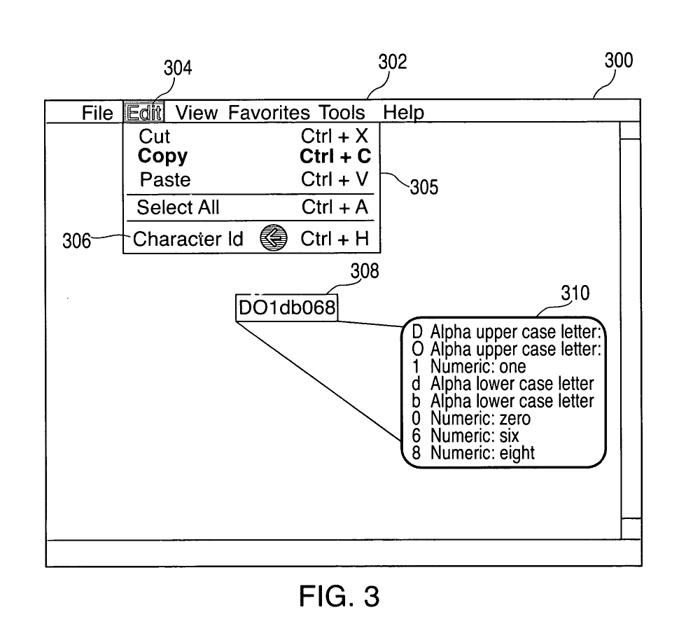

As indicated above, the character identification system 114 includes an application for implementing character recognition processes. An exemplary process for implementing the character identification system 114 is shown and described in FIG. 2. For purposes of illustration, it is assumed that a user on computer 100 is executing an application 112 and is presented with a character string. For example, the user may retrieve a document relating to a purchase (e.g., an invoice for the purchase that is saved on the computer 100). A sample user interface screen depicting a portion of a sample invoice is shown in FIG. 3. The user views a confirmation number 308 which has been assigned by a selling entity and determines that the confirmation number 308 is not legible.

The user selects the confirmation number, or character string 308, at step 202. The selection may be accomplished using a variety of techniques such as highlighting the desired character string 308 using mouse 106 (FIG. 1) or using the shift and arrow keys on keyboard 104 (FIG. 1). In exemplary embodiments, the user initiates the character identification system 114 (FIG. 1) by selecting a character identification function at step 204. The character identification may be implemented via an icon (not shown) displayed on toolbar 302 (FIG. 3) or via a drop down box 305 (FIG. 3) displayed as a result of selecting an option (e.g., ‘edit’ 304) from toolbar 302. As shown in FIG. 3, the character identification function 306 is selected from drop down box 305. It will be understood that other implementation techniques may be utilized in addition to the icon and toolbar menu. For example, the character identification function may be set to ‘default’ whereby selecting the character string automatically initiates the character identification function without any affirmative action on the part of the user. This default mechanism may be particularly useful for individuals who engage in substantial manipulations of alphanumeric character strings.

Upon initiating the character identification function 306, the selected character string 308 is input to the character identification system application at step 206. This character string is also referred to herein as an input string. At step 208, the input string 308 is parsed by the character identification system application. The parse function involves looping through each character in the input string 308 and creating a new output string of characters to be translated. During this process, standard delimiters may be defined as characters that will not be included in the output string (e.g., white space or blank spaces, commas, etc.).

At step 210, the character identification application determines the current code page associated with the input string (e.g., Unicode, ASCII, EBCDIC, etc.). This determination may depend upon where the application is coded (e.g., platform, environment, product, etc.). For Web pages that use HTML or XML, a Webmaster may define the code page using meta tags. For JavaScript, built in functions may be used to query the defined code page that a Webmaster used when creating the page. If the application is coded on a Microsoft® Windows™ platform using C code, the environment variables may be queried to determine the current code page setting. If the application is written on a Unix platform, a setlocale( ) function may be used to obtain the code page. Some applications may use a default code page defined for the application, or environment state variables may be queried to determine the current code page that the user was authorized to customize during installation of the application.

A character identification table is created by the character identification system application at step 212. A sample character identification table 310 with entries is shown in FIG. 3.

At step 214, the character identification application selects a first character from the input string and, using the selected character, queries the code page in order to identify the character at step 216. The identification process used may depend on where the application is written when creating the character identification table.

A few methods may be used to dynamically translate the input string that indicates alpha Uppercase, alpha Lowercase, numeric, etc. The following background is provided for ease in explanation of step 216. Each input character in the character identification table has a coded representation associated with the character that is used to encode the character. The coded representation associated with the character depends on the code page being used. For example, the character “A” is roman (English) alpha, and although the meaning is the same for EBCDIC and ASCII they have different encodings for this character (values 65 and 193, respectively).

The query code page function of step 216 uses the current code page table defined, along with the character coded representation, to translate input characters for determining alpha, numeric, uppercase or lowercase. For example, the ASCII encoded value for “A” is Dec 65, which translates into Uppercase A. The ASCII encoded value for “a” is Dec 97, which translates into Lowercase a. Depending on where the application is running, logic will be used by the character identification system to index into the encoded character table in order to translate the input character value into the associated character identification. Also, functions supported by the application environment may be used to perform the query and translation. For example, the following Unix functions may be used with supporting logic, if available: isalpha( ) tests if the character is an alpha character; isdigit( ) tests if the character is a digit; isupper( ) tests if the character is an uppercase letter; and islower( ) tests if the character is a lowercase letter.

Once identified, the character identification application enters both the selected character and the identification in the character identification table at step 218. At step 220, it is determined whether there are any remaining characters in the input string. If so, the process returns to step 214 whereby the character identification system application selects the next character in the input string for processing. Otherwise, the selected characters and their corresponding identifications are provided to the user within table 310 at step 222. The table may then be printed, saved as a file, or used to write down the character IDs associated with the characters.

As described above, the character identification system provides instant recognition of one or more characters displayed on a computer screen. Characters or character strings may be selected in the course of viewing the characters/strings using any viewer (e.g., Internet browser, editor, word processor, etc.) for identification. A character identification application identifies the selected characters/string and displays the identification in a table format or similar convenient display means. The identification includes differentiating between upper and lower case alpha characters and numeric characters. The identification values may be saved, printed, or transferred to written form for later reference.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for providing instant text character identification, comprising:
querying a code page for a character selected for identification, the querying implemented in response to a request for the identification by a user at a computer device, the request for identification including an input string of characters to be identified;
creating a table and entering the character selected for identification and an identification resulting from the querying; and
displaying the table to a user via the computer device;
wherein the identification includes corresponding alpha properties or numeric properties of the character selected for identification.

2. The method of claim 1, wherein the corresponding alpha properties include an upper and lower case.

3. The method of claim 1, wherein the request for identification is initiated by selecting a character identification function displayed on a toolbar at the computer device.

4. The method of claim 1, wherein the request for identification is initiated by selecting a character identification function represented by an icon on a computer screen of the computer device.

5. The method of claim 1, wherein the request for identification is initiated as a default action in response to highlighting a character or character string.

6. The method of claim 1, wherein the table is at least one of:
printed; and
saved to a file on the computer device.

7. The method of claim 1, further comprising:
parsing the input string, the parsing including:
looping through each character in the input string;
identifying any standard delimiters in the input string; and
creating an output string containing characters to be identified minus the standard delimiters;
wherein the output string is used for said querying a code page.

8. The method of claim 1, wherein the querying further includes:
determining a current code page associated with the output string, the determining based upon at least one of:
a platform upon which an application associated with the output string is executed; and
a program product used in coding the application.

9. A system for providing instant text character identification, comprising:
a computer device executing an operating system and at least one of:
a web browser; and
a word processing application;
a character identification application executing on the computer device, the character identification application performing:
querying a code page for a character selected for identification, the querying implemented in response to a request for the identification by a user at a computer device, the request for identification including an input string of characters to be identified;
creating a table and entering the character selected for identification and an identification resulting from the querying; and
displaying the table to a user via the computer device;
wherein the identification includes corresponding alpha properties or numeric properties of the character selected for identification.

10. The system of claim 9, wherein the corresponding alpha properties include an upper and lower case.

11. The system of claim 9, wherein the request for identification is initiated by selecting a character identification function displayed on a toolbar at the computer device.

12. The system of claim 9, wherein the request for identification is initiated by selecting a character identification function represented by an icon on a computer screen of the computer device.

13. The system of claim 9, wherein the request for identification is initiated as a default action in response to highlighting a character or character string.

14. The system of claim 9, wherein the table is at least one of:
printed; and
saved to a file on the computer device.

15. The system of claim 9, wherein the character identification application performing further performs:
parsing the input string, the parsing including:
looping through each character in the input string;
identifying any standard delimiters in the input string; and
creating an output string containing characters to be identified minus the standard delimiters;
wherein the output string is used for said querying a code page.

16. The system of claim 9, wherein the querying further includes:
determining a current code page associated with the output string, the determining based upon at least one of:
a platform upon which an application associated with the output string is executed; and
a program product used in coding the application.

17. A storage medium encoded with machine-readable program code for providing instant text character identification, the program code including instructions for causing a computer device to implement a method, comprising:
querying a code page for a character selected for identification, the querying implemented in response to a request for the identification by a user at a computer device, the request for identification including an input string of characters to be identified;
creating a table and entering the character selected for identification and an identification resulting from the querying; and
displaying the table to a user via the computer device;
wherein the identification includes corresponding alpha properties or numeric properties of the character selected for identification.

18. The storage medium of claim 17, wherein the corresponding alpha properties include an upper and lower case.

19. The storage medium of claim 17, wherein the request for identification is initiated by selecting a character identification function displayed on a toolbar at the computer device.

20. The storage medium of claim 17, wherein the request for identification is initiated by selecting a character identification function represented by an icon on a computer screen of the computer device.
